(19) United States
(12) Patent Application Publication
(10) Pub. No.: US 2026/0296077 A1
(43) Pub. Date: Oct. 1, 2026

(54) INK RIBBON CARTRIDGE

(71) Applicant: SEIKO EPSON CORPORATION, Tokyo (JP)

(72) Inventors: Kenji MOTAI, Matsumoto-shi (JP); Hibiki AOYAMA, Matsumoto-shi (JP)

(73) Assignee: SEIKO EPSON CORPORATION, Tokyo (JP)

(21) Appl. No.: 19/577,611

(22) Filed: Mar. 25, 2026

(30) Foreign Application Priority Data
Mar. 26, 2025 (JP) 2025-051229

(51) Int. Cl. B41J 32/00; B41J 33/06

(52) U.S. Cl. CPC B41J 32/00; B41J 33/06

(57) ABSTRACT

An ink ribbon cartridge to be mounted on a printing apparatus for performing printing on a tubular print medium that can be introduced from outside, the ink ribbon cartridge including a cartridge case having a medium transport path configured to transport the tubular print medium, and a pressing portion configured to press the tubular print medium in the medium transport path, wherein, when the ink ribbon cartridge mounted on the printing apparatus, the pressing portion presses the tubular print medium in the medium transport path in a predetermined direction including a component of a detachment direction opposite to a mounting direction by engaging with a projection portion provided to project in the detachment direction in a cartridge mounting portion of the printing apparatus.

The present application is based on, and claims priority from JP Application Serial Number 2025-051229, filed Mar. 26, 2025, the disclosure of which is hereby incorporated by reference herein in its entirety.

### BACKGROUND

### 1. Technical Field

The present disclosure relates to an ink ribbon cartridge.

### 2. Related Art

For example, JP-A-2023-4367 discloses a printing apparatus in which an ink ribbon accommodated in an ink ribbon cartridge and a tubular print medium are transported in a state of being pinched between a head and a platen roller, and printing is performed on the tubular print medium by heating the ink ribbon.

In such an ink ribbon cartridge, it is possible to install the tubular print medium by performing an operation of inserting the tubular print medium while continuously pressing an operation lever against the pressurization by a pressurizing member.

However, in such an ink ribbon cartridge, when the tubular print medium is installed, it is necessary to perform an operation of inserting the tubular print medium while continuously pressing the operation lever against the pressurization by the pressurizing member. Therefore, it is desired to improve convenience.

### SUMMARY

An ink ribbon cartridge according to an aspect of the present disclosure is to be mounted on a printing apparatus for performing printing on a tubular print medium that can be introduced from outside, and includes a cartridge case having a medium transport path configured to transport the tubular print medium, and a pressing portion configured to press the tubular print medium in the medium transport path, wherein, when the ink ribbon cartridge is mounted on the printing apparatus, the pressing portion presses the tubular print medium in the medium transport path in a predetermined direction including a component of a detachment direction opposite to a mounting direction by engaging with a projection portion provided to project in the detachment direction in a cartridge mounting portion of the printing apparatus.

### BRIEF DESCRIPTION OF THE DRAWINGS

FIG. 1 is a perspective view illustrating a printing apparatus and an ink ribbon cartridge according to a first embodiment.

FIG. 2 is a top view illustrating the printing apparatus of the first embodiment.

FIG. 3 is a perspective view illustrating the ink ribbon cartridge according to the first embodiment.

FIG. 4 is a perspective view illustrating the ink ribbon cartridge according to the first embodiment.

FIG. 5 is a perspective view illustrating the ink ribbon cartridge according to the first embodiment.

FIG. 6 is a perspective view illustrating the ink ribbon cartridge according to the first embodiment.

FIG. 7 is a perspective view illustrating the ink ribbon cartridge according to the first embodiment.

FIG. 8 is a perspective view illustrating a pressing portion of the first embodiment.

### DESCRIPTION OF EMBODIMENTS

### First embodiment

Hereinafter, an embodiment of an ink ribbon cartridge which can be mounted on a printing apparatus will be described with reference to the drawings. In the following description, in a case where the ink ribbon cartridge is mounted on the printing apparatus in a state where the printing apparatus is installed on a horizontal surface, an axis intersecting the horizontal surface is referred to as a Z-axis, an axis intersecting the Z-axis is referred to as an X-axis, and an axis intersecting the X-axis and the Z-axis is referred to as a Y-axis. One direction along the X-axis is referred to as a first widthwise direction X1, and the other direction along the X-axis is referred to as a second widthwise direction X2. One direction along the Y-axis is referred to as a front side Y1, and the other direction along the Y-axis is referred to as a rear side Y2. An upward direction along the Z-axis is referred to as an upper side Z1, and a downward direction along the Z-axis is referred to as a lower side Z2. A plan view seen from a direction along the Z-axis is simply referred to as a top view.

### Configuration of Printing Apparatus 100

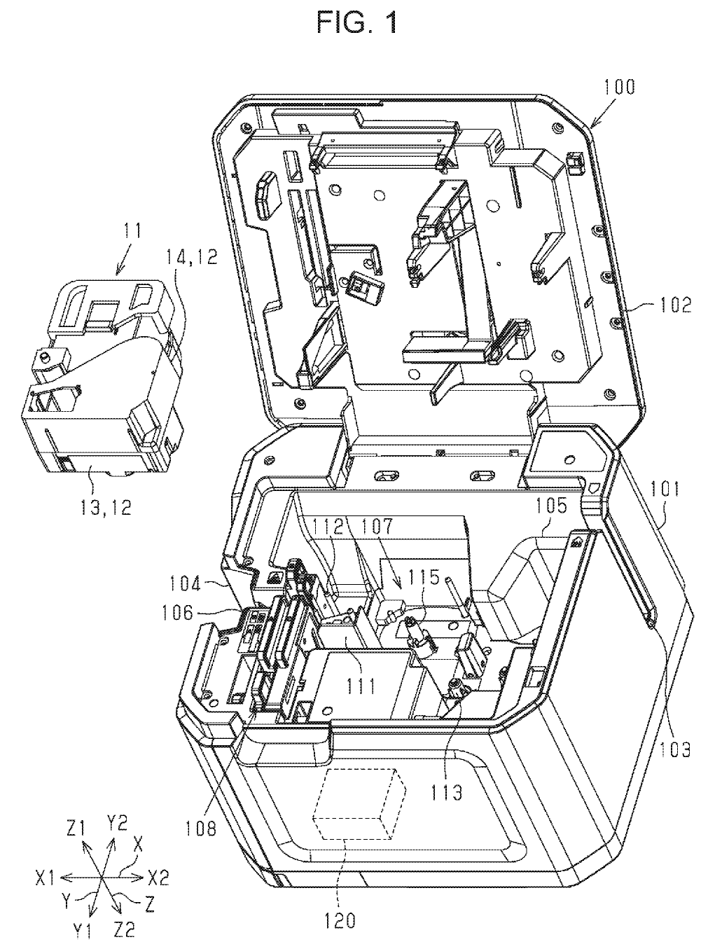

As illustrated in FIG. 1, a printing apparatus 100 is configured to perform printing on a print medium. An ink ribbon cartridge 11 can be mounted on the printing apparatus 100. The printing apparatus 100 is configured to perform printing on a print medium in a state where the ink ribbon cartridge 11 is mounted. The printing apparatus 100 may be configured to perform printing on a print medium which can be introduced from the outside of the printing apparatus 100 and the ink ribbon cartridge 11 in a state where the ink ribbon cartridge 11 is mounted. The print medium may, for example, be a tubular print medium. The tubular print medium may, for example, be a tube.

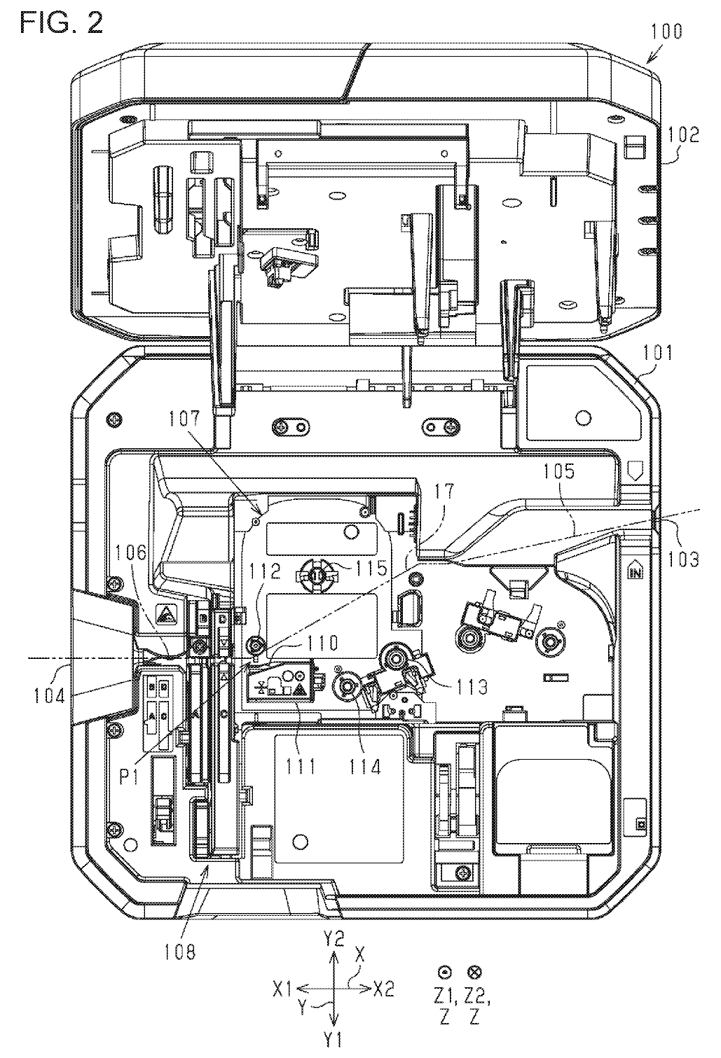

As illustrated in FIG. 2, the printing apparatus 100 includes an apparatus case 101 and an apparatus cover 102. The apparatus case 101 is configured to accommodate various members of the printing apparatus 100. The apparatus case 101 may have a substantially rectangular parallelepiped shape.

The apparatus cover 102 can be opened and closed with respect to the apparatus case 101. The apparatus cover 102 may be rotatably attached to an end portion on the rear side Y2 of the apparatus case 101. The apparatus cover 102 covers the apparatus case 101 from the upper side Z1. The apparatus cover 102 covers the inside of the apparatus case 101. The apparatus cover 102 covers the inside of the apparatus case 101 in a state where the ink ribbon cartridge 11 is mounted.

The apparatus case 101 includes an apparatus side introduction port 103, an apparatus side discharge port 104, an apparatus side introduction path 105, an apparatus side discharge path 106, and a cartridge mounting portion 107. That is, the printing apparatus 100 includes the apparatus side introduction port 103, the apparatus side discharge port 104, the apparatus side introduction path 105, the apparatus side discharge path 106, and the cartridge mounting portion 107.

The apparatus side introduction port 103 may be provided in the second widthwise direction X2 of the apparatus case 101. The apparatus side introduction port 103 may have a shape extending along the Z-axis. The apparatus side introduction port 103 may be a cutout that opens to the upper side Z1. The apparatus side introduction port 103 is a portion for introducing the print medium from the outside of the printing apparatus 100 to the inside of the printing apparatus 100.

The apparatus side discharge port 104 may be provided in the first widthwise direction X1 of the apparatus case 101. The apparatus side discharge port 104 may have a shape extending along the Z-axis. The apparatus side discharge port 104 may be a cutout that opens to the upper side Z1. The apparatus side discharge port 104 is a portion for discharging the print medium from the inside of the printing apparatus 100 to the outside of the printing apparatus 100.

The apparatus side introduction path 105 is provided between the apparatus side introduction port 103 and the cartridge mounting portion 107. The apparatus side introduction path 105 is a path for transporting the print medium introduced from the apparatus side introduction port 103 to the cartridge mounting portion 107 between the apparatus side introduction port 103 and the cartridge mounting portion 107. The apparatus side introduction path 105 may be a recessed portion that opens to the upper side Z1.

The apparatus side discharge path 106 is provided between the cartridge mounting portion 107 and the apparatus side discharge port 104. The apparatus side discharge path 106 is a path for discharging the print medium transported from the cartridge mounting portion 107 from the apparatus side discharge port 104 between the cartridge mounting portion 107 and the apparatus side discharge port 104. The apparatus side discharge path 106 may be a recessed portion that opens to the upper side Z1.

The cartridge mounting portion 107 is a recessed portion that opens to the upper side Z1. The cartridge mounting portion 107 is connected to the apparatus side introduction path 105 in the second widthwise direction X2. The cartridge mounting portion 107 is connected to the apparatus side discharge path 106 in the first widthwise direction X1.

The ink ribbon cartridge 11 can be attached to and detached from the cartridge mounting portion 107 from the upper side Z1. The cartridge mounting portion 107 can accommodate the mounted ink ribbon cartridge 11.

The ink ribbon cartridge 11 in which a print medium has been introduced can be attached to and detached from the cartridge mounting portion 107. In such a case, the print medium introduced into the ink ribbon cartridge 11 can be inserted into the apparatus side introduction port 103 and the apparatus side introduction path 105 from the upper side Z1.

The printing apparatus 100 includes a head 110 and a head cover 111. The head 110 and the head cover 111 are provided in the apparatus case 101. The head 110 and the head cover 111 are provided in the cartridge mounting portion 107.

The head 110 is configured to perform printing on a print medium. The head 110 may be a thermal head that performs printing on a print medium using a heating element. The head 110 is provided at a printing position P1. The printing position P1 is a position at which printing is performed on the print medium by the head 110. The printing position P1 is a position along a medium transport path 17 described further below. The head cover 111 partially covers the head 110.

The printing apparatus 100 includes a platen shaft 112. The platen shaft 112 is provided in the apparatus case 101. The platen shaft 112 is provided in the cartridge mounting portion 107. The platen shaft 112 is provided so as to project from the bottom surface of the cartridge mounting portion 107 toward the upper side Z1. The platen shaft 112 is a shaft for transmitting power to a platen roller 22 of the ink ribbon cartridge 11 described further below.

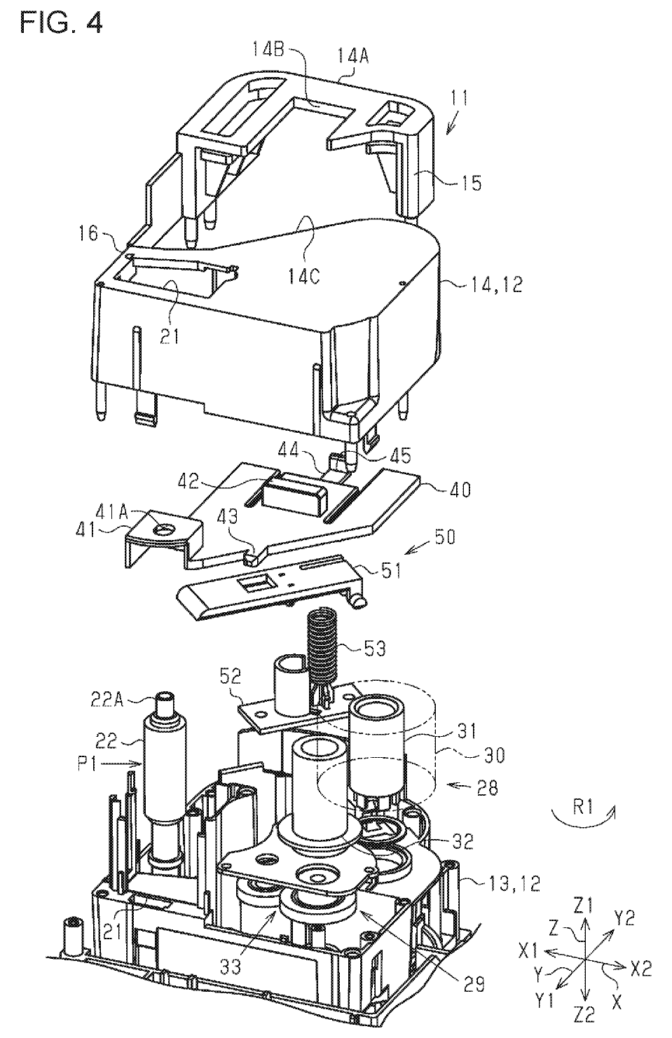

The printing apparatus 100 includes a feed shaft 113. The feed shaft 113 is provided in the apparatus case 101. The feed shaft 113 is provided in the cartridge mounting portion 107. The feed shaft 113 is provided so as to project from the bottom surface of the cartridge mounting portion 107 toward the upper side Z1. The feed shaft 113 is a shaft for feeding an ink ribbon 30 illustrated in FIG. 4 accommodated in the ink ribbon cartridge 11. That is, the feed shaft 113 is a shaft that feeds the ink ribbon 30.

The printing apparatus 100 includes a take-up shaft 114. The take-up shaft 114 is provided in the apparatus case 101. The take-up shaft 114 is provided in the cartridge mounting portion 107. The take-up shaft 114 is provided so as to project from the bottom surface of the cartridge mounting portion 107 toward the upper side Z1. The take-up shaft 114 is a shaft that transmits power for taking up the ink ribbon 30 accommodated in the ink ribbon cartridge 11. That is, the take-up shaft 114 is a shaft that takes up the ink ribbon 30.

The printing apparatus 100 includes a projection portion 115. The projection portion 115 is provided in the apparatus case 101. The projection portion 115 is provided in the cartridge mounting portion 107. The projection portion 115 is provided so as to project toward the upper side Z1. The projection portion 115 may be provided so as to project from the bottom surface of the cartridge mounting portion 107 toward the upper side Z1.

When the apparatus cover 102 is closed in a state where the ink ribbon cartridge 11 is mounted on the cartridge mounting portion 107, the head 110 moves toward the platen roller 22 by a head moving mechanism (not shown). As a result, the print medium and the ink ribbon 30 are pinched between the head 110 and the platen roller 22.

When the platen shaft 112 and the take-up shaft 114 rotate in this state, the print medium and the ink ribbon 30 are fed. At this time, the head 110 generates heat based on print data, so that the ink of the ink ribbon 30 is transferred to the print medium. Thus, printing is performed on the print medium.

In the present embodiment, the ink ribbon cartridge 11 is configured to feed the ink ribbon 30 by taking up the ink ribbon 30 in response to the power from the take-up shaft 114 without receiving the power from the feed shaft 113, but is not limited thereto.

The printing apparatus 100 may include a cutter mechanism 108. The cutter mechanism 108 is provided in the apparatus case 101. The cutter mechanism 108 is provided downstream of the printing position P1 in a transport direction in which the print medium is transported. The cutter mechanism 108 may be provided in the apparatus side discharge path 106. The cutter mechanism 108 is configured to cut the print medium after printing.

As illustrated in FIG. 1, the printing apparatus 100 includes a control unit 120. The control unit 120 integrally controls the printing apparatus 100. The control unit 120 controls various operations executed by the printing apparatus 100. The control unit 120 may be configured as a circuit including α: one or more processors that execute various processes in accordance with a computer program, β: one or more dedicated hardware circuits that execute at least some of the various processes, or γ: a combination thereof. The hardware circuit is, for example, an application-specific integrated circuit. The processor includes a CPU and a memory such as a RAM and a ROM, and the memory stores program codes or instructions configured to cause the CPU to execute the processes. The memory, that is, a computer-readable medium includes any readable medium accessible by a general purpose or dedicated computer.

The control unit 120 can control the head 110. The control unit 120 can control a driving unit (not shown) that drives each of the platen shaft 112, the feed shaft 113, the take-up shaft 114, and the projection portion 115. The control unit 120 can control the cutter mechanism 108.

In the present embodiment, the printing apparatus 100 may be configured such that both the ink ribbon cartridge 11 and a tape cartridge (not shown) can be used. In this way, the printing apparatus 100 may be configured such that the ink ribbon cartridge 11 and the tape cartridge (not shown) can be selectively mounted on the cartridge mounting portion 107.

The tape cartridge is a cartridge that accommodates a print tape roll. The print tape roll is a rolled tape serving as a print medium. The projection portion 115 may be configured to be inserted into the rotation center of the print tape roll when the tape cartridge (not shown) is mounted on the cartridge mounting portion 107. When the tape cartridge (not shown) is mounted on the cartridge mounting portion 107, the projection portion 115 may transmit a driving force for rotating the print tape roll.

### Configuration of Ink Ribbon Cartridge 11

The ink ribbon cartridge 11 can be mounted on the printing apparatus 100. The ink ribbon cartridge 11 can be mounted on the cartridge mounting portion 107. The ink ribbon cartridge 11 is mounted on the printing apparatus 100 so as to face the lower side Z2. The ink ribbon cartridge 11 is removed from the printing apparatus 100 toward the upper side Z1. Thus, the lower side Z2 corresponds to an example of a mounting direction. The upper side Z1 corresponds to an example of a detachment direction which is a direction opposite to the mounting direction.

As illustrated in FIG. 4, the ink ribbon cartridge 11 accommodates the ink ribbon 30. The ink ribbon cartridge 11 may be configured to perform printing on a print medium that can be introduced from the outside of the ink ribbon cartridge 11.

The ink ribbon cartridge 11 includes a cartridge case 12. The cartridge case 12 is the exterior of the ink ribbon cartridge 11. The cartridge case 12 accommodates various components of the ink ribbon cartridge 11. The cartridge case 12 accommodates the ink ribbon 30.

The cartridge case 12 includes a first case 13 and a second case 14. When the ink ribbon cartridge 11 is mounted on the printing apparatus 100, the second case 14 is positioned on the upper side Z1 of the first case 13. The second case 14 is configured to cover the first case 13 from the upper side Z1. Thus, the first case 13 is positioned on the lower side Z2, and the second case 14 is positioned on the upper side Z1.

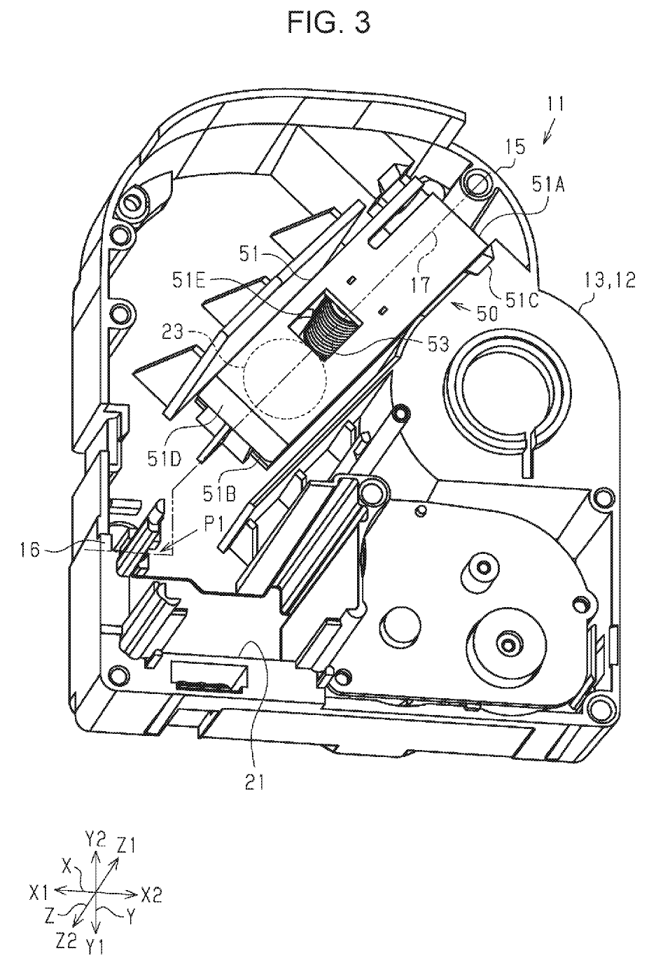

As illustrated in FIG. 3, the cartridge case 12 includes an introduction port 15 and a discharge port 16. The introduction port 15 may be provided on the second widthwise direction X2 side of the cartridge case 12. The introduction port 15 may have a shape extending along the Z-axis. The introduction port 15 may be a cutout that opens to the upper side Z1. The introduction port 15 is provided in the second case 14, but may be provided in the first case 13, or may be provided across the first case 13 and the second case 14. The introduction port 15 is a portion for introducing a print medium from the outside of the cartridge case 12 to the inside of the cartridge case 12.

The discharge port 16 may be provided on the first widthwise direction X1 side of the cartridge case 12. The discharge port 16 may have a shape extending along the Z-axis. The discharge port 16 may be a cutout that opens to the upper side Z1. The discharge port 16 is provided in the second case 14, but may be provided in the first case 13, or may be provided across the first case 13 and the second case 14. The discharge port 16 is a portion for discharging the print medium from the inside of the cartridge case 12.

The cartridge case 12 includes the medium transport path 17. The medium transport path 17 is provided in the second case 14, but may be provided in the first case 13, or may be provided across the first case 13 and the second case 14.

The medium transport path 17 is connected to the introduction port 15 and the discharge port 16 in the cartridge case 12. The medium transport path 17 is a path along which a print medium is transported. The medium transport path 17 is a path for transporting the print medium introduced to the inside of the cartridge case 12 through the introduction port 15.

The medium transport path 17 is a path that connects at least the introduction port 15 and the printing position P1. The medium transport path 17 is a path along which the print medium introduced from the introduction port 15 is transported to the printing position P1. The medium transport path 17 is a path that connects the printing position P1 and the discharge port 16. The medium transport path 17 is a path for transporting the print medium printed at the printing position P1 so that the print medium is discharged from the discharge port 16.

The first case 13 may include an insertion hole 23. That is, the insertion hole 23 may be provided in the cartridge case 12. The insertion hole 23 is a hole that extends through the first case 13 along the Z-axis. The insertion hole 23 is a hole into which the projection portion 115 can be inserted. When the ink ribbon cartridge 11 is mounted on the cartridge mounting portion 107, the projection portion 115 is inserted into the insertion hole 23.

As illustrated in FIGS. 3 and 4, the cartridge case 12 includes a head insertion hole 21. That is, the ink ribbon cartridge 11 includes the head insertion hole 21. The head insertion hole 21 is provided so as to extend through the cartridge case 12 along the Z-axis. Specifically, the head insertion hole 21 is provided in the first case 13 and the second case 14. The head insertion hole 21 is provided so as to extend through the first case 13 and the second case 14.

In a state where the ink ribbon cartridge 11 is mounted on the cartridge mounting portion 107, the head 110 and the head cover 111 are inserted into the head insertion hole 21 toward the upper side Z1. That is, the head 110 can be inserted into the head insertion hole 21 at the printing position P1 in the cartridge case 12. Thus, the upper side Z1 corresponds to an example of an insertion direction in which the head 110 is inserted.

As illustrated in FIG. 4, the second case 14 includes a sidewall 14A. The sidewall 14A is a portion facing the rear side Y2. The sidewall 14A is included in a portion of the cartridge case 12 facing the rear side Y2.

The second case 14 includes a guide groove 14B. The guide groove 14B is provided along the Y-axis. The guide groove 14B is provided so as to open on the front side Y1. The guide groove 14B is provided so as to open the medium transport path 17 at the front side Y1. As will be described in detail later, the guide groove 14B guides the displacement of a movable portion 40 by coming into contact with an operation projection portion 42 in the X-axis. That is, the guide groove 14B is provided along a displacement direction of the movable portion 40.

The second case 14 includes an opening 14C. The opening 14C is provided in the upper surface of the second case 14. The opening 14C is positioned on the upper side Z1 of the medium transport path 17. The opening 14C is opened in the upper side Z1 so that the medium transport path 17 is exposed.

The ink ribbon cartridge 11 may include the platen roller 22. The platen roller 22 is provided in the cartridge case 12. The platen roller 22 is configured to extend along the Z-axis. The platen roller 22 is provided in the second case 14 along the Z-axis, but may be provided so as to straddle the first case 13 and the second case 14.

In a state where the ink ribbon cartridge 11 is mounted on the cartridge mounting portion 107, the platen roller 22 is provided at a position facing the head 110. In a state where the ink ribbon cartridge 11 is mounted on the cartridge mounting portion 107, the platen roller 22 is configured to pinch the print medium and the ink ribbon 30 between the platen roller 22 and the head 110 at the printing position P1.

In a state where the ink ribbon cartridge 11 is mounted on the cartridge mounting portion 107, power is transmitted to the platen roller 22 from the platen shaft 112. The platen roller 22 is connected to the platen shaft 112 via a platen shaft insertion hole (not shown) in the first case 13. The print medium and the ink ribbon 30 are transported along the medium transport path 17 by the rotation of the platen roller 22 while being pinched between the platen roller 22 and the head 110.

In the present embodiment, the print medium has a size equal to or less than half of the length of the ink ribbon cartridge 11 along the Z-axis, but is not limited thereto. The print medium is transported along the medium transport path 17 provided in the second case 14 inside the ink ribbon cartridge 11, but is not limited thereto.

The cartridge case 12 includes an ink ribbon accommodating area 28. The ink ribbon accommodating area 28 is provided on the second case 14 side along the Z-axis. The ink ribbon accommodating area 28 is provided in the second case 14 along the Z-axis, but may be provided so as to straddle the second case 14 and the first case 13.

The ink ribbon accommodating area 28 is an area in which the ink ribbon 30 can be accommodated in the cartridge case 12. The ink ribbon accommodating area 28 is an area for accommodating a feed core 31. The ink ribbon accommodating area 28 is an area for accommodating a feed roll. The feed roll is a roll body around which the ink ribbon 30 to be fed to the printing position P1 is wound. The feed roll includes the feed core 31. The feed roll may include the ink ribbon 30 wound around the feed core 31.

The ink ribbon accommodating area 28 is an area for accommodating a take-up core 32. The ink ribbon accommodating area 28 is an area for accommodating a take-up roll. The take-up roll is a roll body around which the ink ribbon 30 transported from the printing position P1 is wound. The take-up roll includes the take-up core 32. The take-up roll may include the ink ribbon 30 wound around the take-up core 32.

The ink ribbon cartridge 11 includes a gear train accommodating area 29 and a gear train 33. The gear train accommodating area 29 is provided in the cartridge case 12. The gear train accommodating area 29 is an area for accommodating the gear train 33. That is, the gear train 33 is accommodated in the cartridge case 12.

The gear train accommodating area 29 is provided on the first case 13 side along the Z-axis. The gear train accommodating area 29 is provided in the first case 13 along the Z-axis, but may be provided so as to straddle the first case 13 and the second case 14. The gear train accommodating area 29 is provided so as to overlap the ink ribbon accommodating area 28 in the top view.

When the ink ribbon cartridge 11 is mounted on the cartridge mounting portion 107, the gear train 33 is configured to transmit the power of the take-up shaft 114 to the take-up roll. The gear train 33 is connected to the take-up shaft 114 via a take-up shaft insertion hole (not shown) in the first case 13.

The gear train 33 may be configured to rotate the take-up roll in a first circumferential direction R1 when the take-up shaft 114 rotates in the first circumferential direction R1. The gear train 33 may be configured to set the ratio between the rotation speed of the take-up shaft 114 and the rotation speed of the take-up roll to 1:1. The gear train 33 may include an odd number of gears or may include three gears.

Accordingly, in a state where the ink ribbon cartridge 11 is mounted on the cartridge mounting portion 107, the rotation axis of the take-up core 32 is provided to be parallel to the rotation axis of the take-up shaft 114 and is different from the rotation axis of the take-up shaft 114.

### Configuration of Movable Portion 40

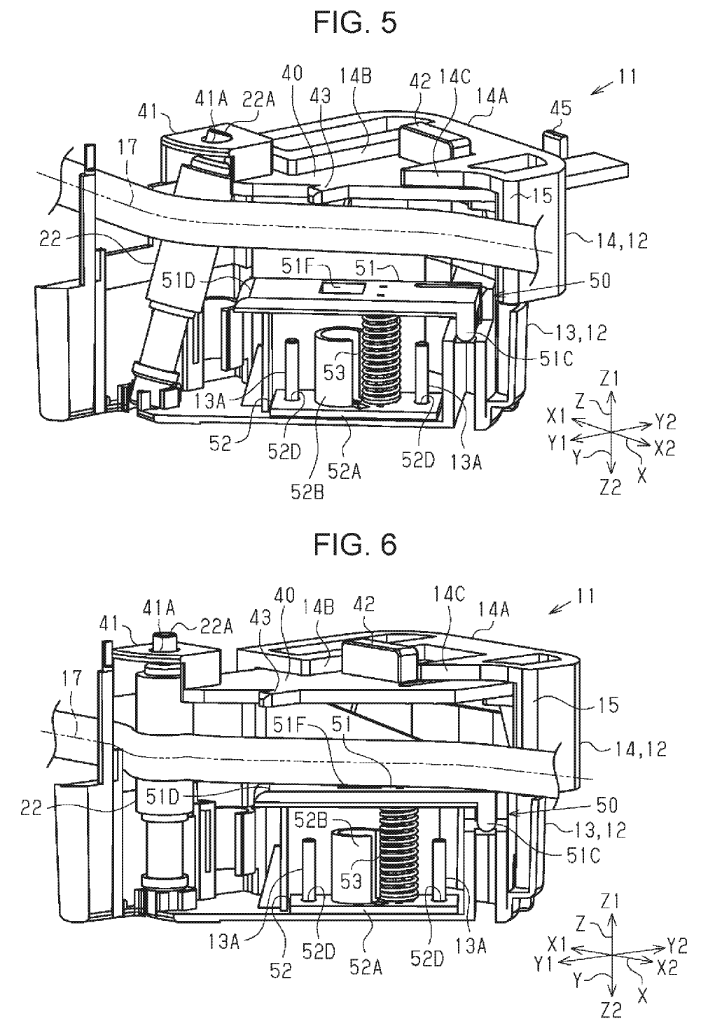

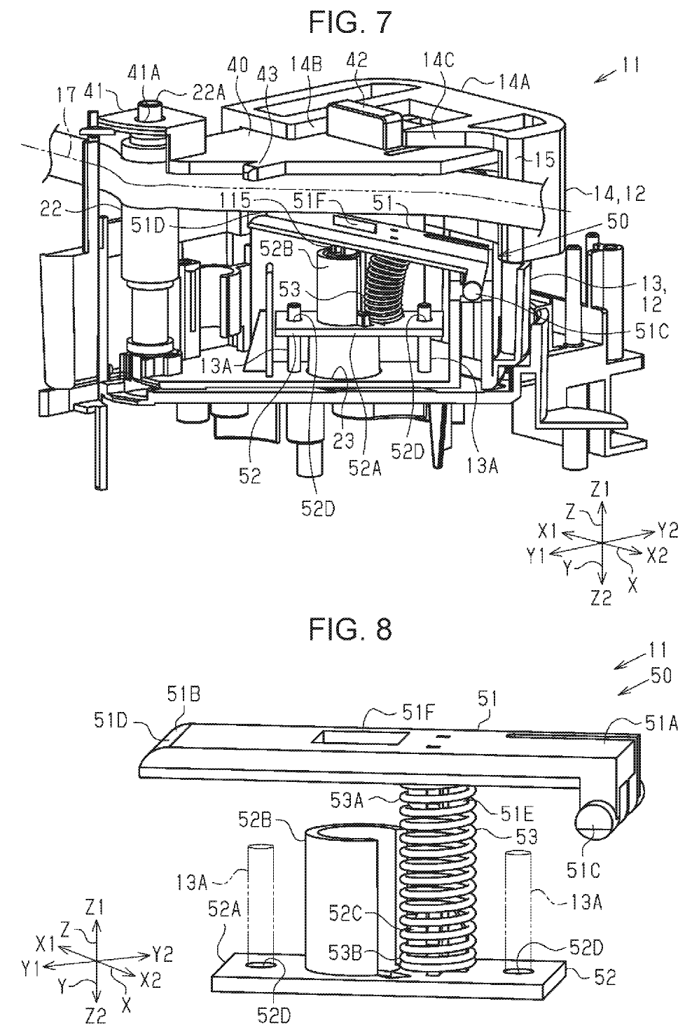

The ink ribbon cartridge 11 includes the movable portion 40. The movable portion 40 is provided in the second case 14. The movable portion 40 is movable along the Y-axis between an open position illustrated in FIG. 5 and a closed position illustrated in FIGS. 6 and 7. The movable portion 40 may include a plate-shaped movable member.

As illustrated in FIG. 5, the open position is a position where the movable portion 40 does not cover the opening 14C. The open position is a position at which the movable portion 40 opens the medium transport path 17. As illustrated in FIGS. 6 and 7, the closed position is a position at which the movable portion 40 covers the opening 14C. The closed position is a position at which the movable portion 40 closes the medium transport path 17.

The movable portion 40 moves from the closed position to the open position by moving to the rear side Y2. The movable portion 40 moves from the open position to the closed position by moving to the front side Y1. The front side Y1 corresponds to an example of a first displacement direction. The rear side Y2 corresponds to an example of a second displacement direction. In this way, the movable portion 40 is configured to open and close the medium transport path 17 from the upper side Z1.

The movable portion 40 may include a platen roller holding portion 41. The platen roller holding portion 41 is provided on the first widthwise direction X1 side of the movable portion 40. The platen roller holding portion 41 is provided on the front side Y1 of the movable portion 40. The platen roller holding portion 41 may be configured to project toward the front side Y1.

The platen roller holding portion 41 may include a through hole 41A. A rotating shaft end portion 22A of the platen roller 22 extends through the through hole 41A. Thus, the platen roller holding portion 41 is configured to rotatably hold the platen roller 22.

The movable portion 40 displaces the platen roller 22 by opening and closing the medium transport path 17. In particular, the movable portion 40 displaces the platen roller 22 to a pinch position by moving to the closed position. The pinch position is a position at which the platen roller 22 pinches the print medium together with the head 110. The pinch position may be a position at which the platen roller 22 is disposed along the Z-axis.

The movable portion 40 displaces the platen roller 22 to a separated position by moving to the open position. The separated position is a position further separated from the medium transport path 17 than the pinch position. The separated position is a position at which the platen roller 22 does not pinch the print medium. The separated position may be a position at which the platen roller 22 is inclined with respect to the Z-axis.

The movable portion 40 may include the operation projection portion 42. The operation projection portion 42 is provided on the upper surface of the movable portion 40. The operation projection portion 42 is configured to project toward the upper side Z1 from the upper surface of the movable portion 40 in the movable portion 40.

The operation projection portion 42 is exposed from the second case 14. The operation projection portion 42 is exposed from the second case 14 through the guide groove 14B. The operation projection portion 42 is a portion for operating the movement of the movable portion 40. The operation projection portion 42 may be a finger hooking projection portion on which a user's finger is hooked. The operation projection portion 42 is guided along the guide groove 14B in a state of being exposed from the second case 14 according to the displacement of the movable portion 40 along the Y-axis.

The movable portion 40 may include a first engagement portion 43. The first engagement portion 43 is provided on the front side Y1 of the movable portion 40. When the movable portion 40 is disposed at the closed position, the first engagement portion 43 engages with the cartridge case 12 at the front side Y1. When the movable portion 40 is disposed at the closed position, the first engagement portion 43 engages with the cartridge case 12 at the upper side Z1 of the medium transport path 17.

As illustrated in FIG. 4, the movable portion 40 may include a flexible portion 44 and a second engagement portion 45. The flexible portion 44 is provided on the rear side Y2 of the movable portion 40. The flexible portion 44 is configured to extend to the rear side Y2. The flexible portion 44 is configured to bend in response to a force along the Z-axis.

The second engagement portion 45 is provided on the rear side Y2 of the movable portion 40. The second engagement portion 45 is provided on a distal end portion of the flexible portion 44. The second engagement portion 45 is configured to extend to the upper side Z1 at the distal end portion of the flexible portion 44.

When the movable portion 40 is moved from the open position to the front side Y1, the second engagement portion 45 comes into contact with a projection (not shown) of the second case 14. The projection is configured to project toward the lower side Z2. The second engagement portion 45 comes into contact with the projection. As a result, the flexible portion 44 is bent so that the second engagement portion 45 is displaced toward the lower side Z2, and the second engagement portion 45 rides over the projection to be positioned on the front side Y1 with respect to the projection. In this way, the movable portion 40 moves from the open position to the closed position. The second engagement portion 45 engages with the projection, but need not engage with the projection. When the movable portion 40 moves from the open position to the closed position, an operation with a click feeling is made possible.

When the movable portion 40 moves from the open position to the closed position to close the medium transport path 17, the second engagement portion 45 does not project outward from the sidewall 14A on the rear side Y2 of the second case 14. In this case, the second engagement portion 45 is configured to engage with the second case 14.

When the movable portion 40 moves from the closed position to the rear side Y2, the second engagement portion 45 and the projection come into contact with each other, the flexible portion 44 is bent such that the second engagement portion 45 is displaced toward the lower side Z2, and the second engagement portion 45 rides over the projection to be positioned on the rear side Y2 with respect to the projection. As a result, the movable portion 40 moves from the closed position to the open position. In this case, the movable portion 40 may be operated so as to move to the rear side Y2 in a state where the operation projection portion 42 is pushed down from the upper side Z1.

When the movable portion 40 moves from the closed position to the open position to open the medium transport path 17, the second engagement portion 45 is positioned so as to project outward from the sidewall 14A on the rear side Y2 of the second case 14. That is, when the movable portion 40 moves from the closed position to the open position, the second engagement portion 45 is positioned so as to project outward from the sidewall 14A on the rear side Y2 of the cartridge case 12.

### Configuration of Pressing Portion 50

The ink ribbon cartridge 11 includes the pressing portion 50. The pressing portion 50 is accommodated in the first case 13. The pressing portion 50 is configured to press the print medium in a predetermined direction in the medium transport path 17. The predetermined direction includes a component of the upper side Z1.

As illustrated in FIG. 8, the pressing portion 50 includes a pressing member 51, a base portion 52, and an elastic member 53. The pressing member 51 is configured to extend along the medium transport path 17. The pressing member 51 may have a flat plate shape. The pressing member 51 is configured to press the print medium.

The pressing member 51 includes an upstream end portion 51A and a downstream end portion 51B. The upstream end portion 51A is an end portion on the upstream side of the medium transport path 17. The downstream end portion 51B is an end portion on the downstream side of the medium transport path 17.

The pressing member 51 includes a rotating shaft 51C. The rotating shaft 51C is provided at the upstream end portion 51A. The rotating shaft 51C may be provided at the upstream end portion 51A at a position projecting toward the lower side Z2. The rotating shaft 51C extends in a direction intersecting the medium transport path 17 and the Z-axis. The rotating shaft 51C is rotatably supported by the first case 13. Thus, the pressing member 51 is rotatable about the rotating shaft 51C.

The pressing member 51 includes a contact portion 51D. The contact portion 51D is provided on the downstream end portion 51B. The contact portion 51D is configured to come into contact with the print medium transported along the medium transport path 17 at the downstream end portion 51B. The contact portion 51D has a curved surface area that comes into contact with the print medium on the upper surface. The contact portion 51D is configured to press the print medium in the predetermined direction in the medium transport path 17 when the ink ribbon cartridge 11 is mounted on the printing apparatus 100.

The pressing member 51 includes a first support portion 51E. The first support portion 51E is provided between the upstream end portion 51A and the downstream end portion 51B of the pressing member 51. The first support portion 51E is configured to project toward the lower side Z2. The first support portion 51E is configured to support the elastic member 53.

The pressing member 51 includes a projection insertion hole 51F. The projection insertion hole 51F is provided between the upstream end portion 51A and the downstream end portion 51B of the pressing member 51. That is, the projection insertion hole 51F is provided between the rotating shaft 51C and the contact portion 51D. The projection insertion hole 51F is provided on the downstream side of the first support portion 51E along the medium transport path 17, but may be provided on the upstream side of the medium transport path 17. The projection insertion hole 51F is a hole extending along the Z-axis. When the ink ribbon cartridge 11 is mounted on the printing apparatus 100, the projection portion 115 can be inserted into the opening.

The base portion 52 is positioned on the lower side Z2 of the pressing member 51. The base portion 52 is configured to hold the elastic member 53. The base portion 52 includes a base body 52A and a cylindrical portion 52B. The base body 52A is configured to extend along the medium transport path 17. The base body 52A has a flat plate shape.

The base body 52A includes a second support portion 52C. That is, the base portion 52 includes the second support portion 52C. The second support portion 52C is provided on a central portion of the base body 52A along the medium transport path 17. The second support portion 52C is provided on the upstream side of the cylindrical portion 52B along the medium transport path 17. The second support portion 52C is positioned between the rotating shaft 51C and the cylindrical portion 52B in the top view. The second support portion 52C is configured to project toward the upper side Z1. The second support portion 52C is configured to support the elastic member 53.

The base body 52A may include a guide hole 52D. The base body 52A may include a pair of guide holes 52D. The pair of guide holes 52D is provided such that the cylindrical portion 52B and the second support portion 52C are interposed therebetween in a direction along the medium transport path 17 in the top view. The guide holes 52D are holes extending along the Z-axis. The pair of guide holes 52D can be inserted into a pair of guide portions 13A to be described later, respectively.

The cylindrical portion 52B is provided on a central portion of the base body 52A along the medium transport path 17. The cylindrical portion 52B is provided on the downstream side of the second support portion 52C along the medium transport path 17. The cylindrical portion 52B is configured to project from the base body 52A toward the upper side Z1. The projection portion 115 is inserted into the cylindrical portion 52B at the time of mounting on the printing apparatus 100. The cylindrical portion 52B is configured to be engaged with the projection portion 115 when the ink ribbon cartridge 11 is mounted on the printing apparatus 100. That is, the base portion 52 is configured to be engaged with the projection portion 115 when the ink ribbon cartridge 11 is mounted on the printing apparatus 100.

The elastic member 53 is provided between the pressing member 51 and the base portion 52. An upper end portion 53A of the elastic member 53 is supported by the first support portion 51E. A lower end portion 53B of the elastic member 53 is supported by the second support portion 52C. The elastic member 53 is disposed so as to press the pressing member 51 toward the upper side Z1.

The first case 13 includes the guide portion 13A. The first case 13 may include a pair of guide portions 13A. The guide portion 13A may include a guide pin extending from the bottom surface of the first case 13 toward the upper side Z1. The guide portion 13A is configured to movably guide the base portion 52 along the Z-axis. Note that the first case 13 may be provided with a guide hole, and the base portion 52 may be provided with a guide pin extending toward the lower side Z2.

### Operation of Ink Ribbon Cartridge 11

The ink ribbon cartridge 11 illustrated in FIG. 5 is removed from the printing apparatus 100. In the ink ribbon cartridge 11, the movable portion 40 is disposed at the open position. The medium transport path 17 is open on the upper side Z1. The platen roller 22 is disposed at the separated position.

In this way, the print medium can be installed in the medium transport path 17 from the upper side Z1, and is not pressed by the platen roller 22 even around the platen roller 22. As a result, the print medium can be easily installed in the ink ribbon cartridge 11.

As illustrated in FIG. 6, in the ink ribbon cartridge 11, when the movable portion 40 moves from the open position to the closed position, the medium transport path 17 is closed on the upper side Z1. The platen roller 22 is displaced from the separated position to the pinch position.

The ink ribbon cartridge 11 illustrated in FIG. 7 is mounted on the printing apparatus 100. In this case, the projection portion 115 is inserted into the cylindrical portion 52B in a state of being engaged with the cylindrical portion 52B via the insertion hole 23. When the projection portion 115 is engaged with the cylindrical portion 52B, the base portion 52 moves toward the upper side Z1 along the guide portion 13A against the elastic force of the elastic member 53. As a result, the elastic member 53 presses the pressing member 51 toward the upper side Z1.

The pressing member 51 is rotated about the rotating shaft 51C by the elastic force from the elastic member 53. As a result, the contact portion 51D moves to the upper side Z1. The contact portion 51D is pressed toward the upper side Z1 in the medium transport path 17.

In this way, when the ink ribbon cartridge 11 is mounted on the printing apparatus 100, the pressing portion 50 presses the print medium in the predetermined direction in the medium transport path 17 by being engaged with the projection portion 115. In particular, when the movable portion 40 is disposed at the closed position, the pressing portion 50 presses the print medium in the predetermined direction to pinch the print medium between the pressing portion 50 and the movable portion 40.

### Operation and Effect of First Embodiment

The operation and effect of the first embodiment will be described.
(1) The pressing portion 50 presses the print medium in the predetermined direction including a component of the upper side Z1 in the medium transport path 17 by engaging with the projection portion 115 at the time of mounting on the printing apparatus 100. According to this configuration, when the ink ribbon cartridge 11 is mounted on the printing apparatus 100, the pressing portion 50 is engaged with the projection portion 115, so that the print medium is pressed in the predetermined direction including a component of the upper side Z1 in the medium transport path 17. Accordingly, it is possible to dispose the print medium at an appropriate position upon performing the mounting operation on the printing apparatus 100. Therefore, the operability can be improved. Therefore, convenience can be improved.
(2) The pressing portion 50 includes the pressing member 51 which extends along the medium transport path 17, the elastic member 53 which presses the pressing member 51 toward the upper side Z1, and the base portion 52 which holds the elastic member 53 and with which the projection portion 115 engages at the time of mounting on the printing apparatus 100. According to this configuration, the pressing member 51 presses the print medium in the predetermined direction by the elastic force of the elastic member 53 as intended by the designer. Therefore, the print medium can be adjusted to an appropriate position. Therefore, convenience can be improved.
(3) The base portion 52 includes the guide hole 52D into which the guide portion 13A extending toward the upper side Z1 can be inserted. According to this configuration, by moving the base portion 52 along the guide portion 13A, the pressing member 51 can be rotated as intended by the designer. Thus, the pressing member 51 can press the print medium in the direction intended by the designer. Therefore, the print medium can be adjusted to an appropriate position. Therefore, convenience can be improved.
(4) The pressing member 51 includes the rotating shaft 51C provided at the upstream end portion 51A on the upstream side of the medium transport path 17, the contact portion 51D that comes into contact with the print medium at the downstream end portion 51B on the downstream side of the medium transport path 17, and the first support portion 51E that supports the elastic member 53. The contact portion 51D presses the print medium in the predetermined direction in the medium transport path 17 at the time of mounting on the printing apparatus 100. According to this configuration, it is possible to smoothly transport the print medium in the medium transport path 17 while the pressing member 51 presses the print medium in the predetermined direction on the downstream side of the medium transport path 17. Therefore, the print medium can be adjusted to an appropriate position. Therefore, convenience can be improved.
(5) The contact portion 51D includes the curved surface area that comes into contact with the print medium. According to this configuration, it is possible to smoothly transport the print medium in the medium transport path 17 while the pressing member 51 presses the print medium in the predetermined direction on the downstream side of the medium transport path 17. Therefore, the print medium can be adjusted to an appropriate position. Therefore, convenience can be improved.
(6) The base portion 52 is provided with the cylindrical portion 52B into which the projection portion 115 is inserted at the time of mounting on the printing apparatus 100 and a second support portion 52C that supports the elastic member 53. In the top view, the second support portion 52C is positioned between the rotating shaft 51C and the cylindrical portion 52B. According to this configuration, the elastic force of the elastic member 53 is transmitted between the rotating shaft 51C and the cylindrical portion 52B with which the projection portion 115 engages. Thus, the pressing member 51 can press the print medium in the direction intended by the designer. Therefore, the print medium can be adjusted to an appropriate position. Therefore, convenience can be improved.
(7) The pressing member 51 includes, between the rotating shaft 51C and the contact portion 51D, a projection insertion hole 51F into which the projection portion 115 can be inserted at the time of mounting on the printing apparatus 100. According to this configuration, since the projection portion 115 is inserted into the projection insertion hole 51F at the time of mounting on the printing apparatus 100, it is possible to reduce a direct influence due to the projection portion 115 coming into contact with the pressing member 51. Therefore, the print medium can be adjusted to an appropriate position. Therefore, convenience can be improved.
(8) The movable portion 40 can open and close the medium transport path 17 from the upper side Z1. In a case where the movable portion 40 is disposed at the closed position at which the medium transport path 17 is closed, the pressing portion 50 presses the print medium in the predetermined direction, and thus the print medium is pinched between the pressing portion 50 and the movable portion 40. According to this configuration, it is possible to easily dispose the print medium in the medium transport path 17 by opening the medium transport path 17 using the movable portion 40. Therefore, the operability can be improved. Since the medium transport path 17 is closed by the movable portion 40, it is possible to suppress interference with the print medium disposed in the medium transport path 17. Therefore, the print medium can be adjusted to an appropriate position. Therefore, convenience can be improved.
(9) The movable portion 40 includes the first engagement portion 43 that engages with the cartridge case 12 at the front side Y1 and a second engagement portion 45 that engages with the cartridge case 12 at the rear side Y2 when the movable portion 40 is disposed at the closed position. According to this configuration, when the movable portion 40 is disposed at the closed position, the movable portion 40 engages with the cartridge case 12 at both of the front side Y1 and the rear side Y2. Accordingly, the movable portion 40 can be stably disposed at the closed position. Therefore, convenience can be improved.

### MODIFICATION EXAMPLE

The embodiments presented herein can be modified and implemented as follows. The embodiments and the following modifications can be implemented in combination with each other in a technically consistent range.

The ink ribbon accommodating area 28 may be provided across the first case 13 and the second case 14. The gear train accommodating area 29 may be provided across the first case 13 and the second case 14 as long as the gear train 33 is disposed at a position where the gear train 33 does not interfere with the take-up core 32 in the Z-axis.

In the gear train 33, the ratio between the rotation speed of the take-up shaft 114 and the rotation speed of the take-up core 32 need not be 1:1. That is, the gear train 33 may be configured such that the rotation speed of the take-up core 32 is slower than the rotation speed of the take-up shaft 114. The gear train 33 may be configured such that the rotation speed of the take-up core 32 is higher than the rotation speed of the take-up shaft 114.

The gear train 33 may rotate the take-up shaft 114 and the take-up core 32 in the same direction which is opposite to the first circumferential direction R1. In the gear train 33, a rotation direction of the take-up shaft 114 need not be the same as a rotation direction of the take-up core 32.

The gear train 33 may include two or four or more gears. The gear train 33 may include an odd number of gears so that the rotation direction of the take-up shaft 114 is the same as the rotation direction of the take-up core 32. The plurality of gears included in the gear train 33 may include gears whose rotation axes are not parallel. The ink ribbon cartridge 11 need not include the gear train 33.

The movable portion 40 closes at least a part of the medium transport path 17 at the closed position, and may close the entire medium transport path 17 at the closed position. The movable portion 40 may open at least a part of the medium transport path 17 at the open position, and may open the entire medium transport path 17 at the open position.

The ink ribbon cartridge 11 need not include the movable portion 40. In this case, before the ink ribbon cartridge 11 is mounted on the printing apparatus 100, the print medium may be introduced from the outside to the inside of the ink ribbon cartridge 11 through the introduction port 15 and may be drawn into the medium transport path 17.

The predetermined direction may be any direction as long as the direction includes a component of the upper side Z1. That is, the predetermined direction may be any direction as long as the direction includes a component of the detachment direction.

After the ink ribbon cartridge 11 is mounted on the printing apparatus 100, the print medium may be introduced from the outside to the inside of the ink ribbon cartridge 11 through the introduction port 15 and may be drawn into the medium transport path 17.

The printing apparatus 100 may include the platen roller 22 itself. The ink ribbon cartridge 11 may include a platen roller insertion hole without including the platen roller 22. The platen roller insertion hole is a hole into which the platen roller 22 can be inserted. When the ink ribbon cartridge 11 is mounted on the cartridge mounting portion 107, the platen roller 22 is inserted into the platen roller insertion hole.

· The expression "at least any one" used in the present specification means one or more of desired options. As an example, the expression "at least any one" used in the present specification means only one option or both of two options when the number of options is two. In another example, the expression "at least any one" used in the present specification means only one option or a combination of any two or more options when the number of options is three or more.

### APPENDIX

Hereinafter, the technical ideas and the operation and effect understood from the above-described embodiments and modifications will be described. The technical ideas and the operation and effect thereof can be combined with each other in a technically consistent range.

[1] An ink ribbon cartridge to be mounted on a printing apparatus for performing printing on a tubular print medium that can be introduced from outside, the ink ribbon cartridge including: a cartridge case having a medium transport path configured to transport the tubular print medium; and a pressing portion configured to press the tubular print medium in the medium transport path, wherein, when the ink ribbon cartridge is mounted on the printing apparatus, the pressing portion presses the tubular print medium in the medium transport path in a predetermined direction including a component of a detachment direction opposite to a mounting direction by engaging with a projection portion provided to project in the detachment direction in a cartridge mounting portion of the printing apparatus.

According to this configuration, when the ink ribbon cartridge is mounted on the printing apparatus, the pressing portion is engaged with the projection portion, so that the tubular print medium is pressed in the predetermined direction including a component of the detachment direction in the medium transport path. Accordingly, it is possible to dispose the tubular print medium at an appropriate position upon performing the mounting operation on the printing apparatus. Therefore, the operability can be improved. Therefore, convenience can be improved.

[2] In the ink ribbon cartridge, the pressing portion includes: a pressing member extending along the medium transport path and configured to press the tubular print medium; an elastic member configured to press the pressing member in the detachment direction; and a base portion holding the elastic member and configured such that the projection portion engages with the base portion when the ink ribbon cartridge is mounted on the printing apparatus.

According to this configuration, the pressing member presses the tubular print medium in the predetermined direction by the elastic force of the elastic member as intended by the designer. Therefore, the tubular print medium can be adjusted to an appropriate position. Therefore, convenience can be improved.

[3] In the ink ribbon cartridge, the base portion includes a guide hole into which a guide pin extending in the detachment direction can be inserted.

According to this configuration, by moving the base portion along the guide pin, the pressing member can be rotated as intended by the designer. Accordingly, the pressing member can press the tubular print medium in the direction intended by the designer. Therefore, the tubular print medium can be adjusted to an appropriate position. Therefore, convenience can be improved.

[4] In the ink ribbon cartridge, the pressing member includes: a rotating shaft provided at an upstream end portion on an upstream side of the medium transport path; a contact portion configured to come into contact with the tubular print medium at a downstream end portion on a downstream side of the medium transport path; and a first support portion projecting in the mounting direction and supporting the elastic member, and the contact portion presses the tubular print medium in the predetermined direction in the medium transport path when the ink ribbon cartridge is mounted on the printing apparatus.

According to this configuration, it is possible to smoothly transport the tubular print medium in the medium transport path while the pressing member presses the tubular print medium in the predetermined direction on the downstream side of the medium transport path. Therefore, the tubular print medium can be adjusted to an appropriate position. Therefore, convenience can be improved.

[5] In the ink ribbon cartridge, the contact portion includes a curved surface area configured to come into contact with the tubular print medium.

According to this configuration, it is possible to smoothly transport the tubular print medium in the medium transport path while the pressing member presses the tubular print medium in the predetermined direction on the downstream side of the medium transport path. Therefore, the tubular print medium can be adjusted to an appropriate position. Therefore, convenience can be improved.

[6] In the ink ribbon cartridge, the base portion includes: a cylindrical portion projecting in the detachment direction and configured such that the projection portion is inserted into the cylindrical portion when the ink ribbon cartridge is mounted on the printing apparatus; and a second support portion projecting in the detachment direction and supporting the elastic member, and the second support portion is positioned between the rotating shaft and the cylindrical portion in a plan view from the mounting direction.

According to this configuration, the elastic force of the elastic member is transmitted between the rotating shaft of the pressing portion and the cylindrical portion with which the projection portion engages. Accordingly, the pressing member can press the tubular print medium in the direction intended by the designer. Therefore, the tubular print medium can be adjusted to an appropriate position. Therefore, convenience can be improved.

[7] In the ink ribbon cartridge, the pressing member includes, between the rotating shaft and the contact portion, a projection insertion hole into which the projection portion can be inserted when the ink ribbon cartridge is mounted on the printing apparatus.

According to this configuration, since the projection portion is inserted into the projection insertion hole at the time of mounting on the printing apparatus, it is possible to reduce a direct influence due to the projection portion coming into to contact with the pressing member. Therefore, the tubular print medium can be adjusted to an appropriate position. Therefore, convenience can be improved.

[8] The ink ribbon cartridge further includes a movable portion capable of opening and closing the medium transport path from a side of the detachment direction, and when the movable portion is disposed at a closed position at which the medium transport path is closed, the pressing portion presses the tubular print medium in the predetermined direction thereby pinching the tubular print medium between the pressing portion and the movable portion.

According to this configuration, it is possible to easily dispose the tubular print medium in the medium transport path by opening the medium transport path using the movable portion. Therefore, the operability can be improved. Since the medium transport path is closed by the movable portion, it is possible to suppress interference with the tubular print medium disposed in the medium transport path. Therefore, the tubular print medium can be adjusted to an appropriate position. Therefore, convenience can be improved.

[9] In the ink ribbon cartridge, the movable portion moves from an open position at which the medium transport path is open to the closed position by moving in a first displacement direction intersecting the mounting direction, and the movable portion includes a first engagement portion configured to engage with the cartridge case in the first displacement direction and a second engagement portion configured to engage with the cartridge case in a second displacement direction opposite to the first displacement direction, when the movable portion is disposed at the closed position.

According to this configuration, when the movable portion is disposed at the closed position, the movable portion engages with the cartridge case in both the first displacement direction and the second displacement direction. Accordingly, the movable portion can be stably disposed at the closed position. Therefore, convenience can be improved.

What is claimed is:

1. An ink ribbon cartridge to be mounted on a printing apparatus for performing printing on a tubular print medium that can be introduced from outside, the ink ribbon cartridge comprising:
a cartridge case having a medium transport path configured to transport the tubular print medium; and
a pressing portion configured to press the tubular print medium in the medium transport path,
wherein, when the ink ribbon cartridge is mounted on the printing apparatus, the pressing portion presses the tubular print medium in the medium transport path in a predetermined direction including a component of a detachment direction opposite to a mounting direction by engaging with a projection portion provided to project in the detachment direction in a cartridge mounting portion of the printing apparatus.

2. The ink ribbon cartridge according to claim 1,
wherein the pressing portion includes:
a pressing member extending along the medium transport path and configured to press the tubular print medium;
an elastic member configured to press the pressing member in the detachment direction; and
a base portion holding the elastic member and configured such that the projection portion engages with the base portion when the ink ribbon cartridge is mounted on the printing apparatus.

3. The ink ribbon cartridge according to claim 2,
wherein the base portion includes a guide hole into which a guide pin extending in the detachment direction can be inserted.

4. The ink ribbon cartridge according to claim 3,
wherein the pressing member includes:
a rotating shaft provided at an upstream end portion on an upstream side of the medium transport path;
a contact portion configured to come into contact with the tubular print medium at a downstream end portion on a downstream side of the medium transport path; and
a first support portion projecting in the mounting direction and supporting the elastic member, and
wherein the contact portion presses the tubular print medium in the predetermined direction in the medium transport path when the ink ribbon cartridge is mounted on the printing apparatus.

5. The ink ribbon cartridge according to claim 4,
wherein the contact portion includes a curved surface area configured to come into contact with the tubular print medium.

6. The ink ribbon cartridge according to claim 4,
wherein the base portion includes:
a cylindrical portion projecting in the detachment direction and configured such that the projection portion is inserted into the cylindrical portion when the ink ribbon cartridge is mounted on the printing apparatus; and
a second support portion projecting in the detachment direction and supporting the elastic member, and
wherein the second support portion is positioned between the rotating shaft and the cylindrical portion in a plan view from the mounting direction.

7. The ink ribbon cartridge according to claim 4,
wherein the pressing member includes, between the rotating shaft and the contact portion, a projection insertion hole into which the projection portion can be inserted when the ink ribbon cartridge is mounted on the printing apparatus.

8. The ink ribbon cartridge according to claim 4,
further comprising a movable portion capable of opening and closing the medium transport path from a side of the detachment direction,
wherein, when the movable portion is disposed at a closed position at which the medium transport path is closed, the pressing portion presses the tubular print medium in the predetermined direction thereby pinching the tubular print medium between the pressing portion and the movable portion.

9. The ink ribbon cartridge according to claim 8,
wherein the movable portion moves from an open position at which the medium transport path is open to the closed position by moving in a first displacement direction intersecting the mounting direction, and
wherein the movable portion includes a first engagement portion configured to engage with the cartridge case in the first displacement direction and a second engagement portion configured to engage with the cartridge case in a second displacement direction opposite to the first displacement direction, when the movable portion is disposed at the closed position.
